(19) United States
(12) Patent Application Publication
(10) Pub. No.: US 2007/0121668 A1
(43) Pub. Date: May 31, 2007

(54) Firmware architecture of active-active fibre channel capability in SATA and SAS devices

(76) Inventors: Michael Moretti, Palo Alto, CA (US); Kelvin Kao, San Jose, CA (US)

Correspondence Address: RAJ ABHYANKER, LLP;c/o PORTFOLIOIP, P.O. BOX 52050, MINNEAPOLIS, MN, 55402, US

(21) Appl. No.: 11/370,128

(22) Filed: Mar. 7, 2006

Related U.S. Application Data
(63) Continuation-in-part of application No. 11/291,116, filed on Nov. 30, 2005.

(51) Int. Cl. H04J 3/22

(52) U.S. Cl. 370/465

(57) ABSTRACT

Firmware architecture of active-active fibre channel capability in SAS and SATA is disclosed. In one embodiment, a system includes a processor and a memory connected to the processor having stored therein a conversion firmware to cause the processor to translate between a fibre channel frame and a SATA frame or a SAS frame. In another example embodiment, and article of manufacture is based on a machine readable medium having a machine readable program which may include functions for analyzing and incoming command of an initiator and performing a conversion of the incoming command to a format of an output line, determining whether the incoming command is compatible with the output line, processing the incoming command internally if it is incompatible with the output line by applying and algorithm, and communicating the incoming command to a destination device if it is compatible with the output line.

### CLAIM OF PRIORITY

This application claims priority from the non-provisional application Ser. No. 11/291,116 titled “Active-active fibre channel capability in SATA and SAS devices” filed on Nov. 30^{th}, 2005.

### FIELD OF TECHNOLOGY

This disclosure relates generally to the technical fields of storage environments, in one example embodiment, to a firmware architecture of active-active fibre channel capability in SAS and SATA system and method.

### BACKGROUND

Fibre channel is a high performance serial link supporting its own, as well as higher-level protocols such as the Fiber Distributed Data Interface (FDDI), Small Computer System Interface (SCSI), High-Performance Parallel Interface (HIPPI), and Internet Policy Institute (IPI) protocols. Fibre channel is often used as a transport mechanism in storage area networks (SANs) in which personal computers and servers are connected to storage devices and other peripherals through a fibre channel transport. By moving storage to a SAN, administrators have the bandwidth to share and/or allocate storage to a much larger audience on a network. The fibre channel transport mechanism can often be used because it allows for fast transfer of large amounts of information to and from nodes of a SAN.

Serial Advanced Technology Attachment (serial ATA) devices (e.g., SATA hard drives) are frequently used as storage devices in personal computers. Consequently, serial ATA devices are manufactured in very high volumes. Fibre channel devices (e.g., specialized fibre channel hard drives based on the SCSI standard) are manufactured in low volumes, because they are primarily used in SAN environments. As a result, serial ATA devices tend to be less costly than fibre channel devices because of reasons including economies of scale achieved through higher volume production of serial ATA devices. For example, component costs for serial ATA devices can cost 3-5 times less than the cost of components for fibre channel devices. In addition, serial ATA devices have a thin serial cable that facilitates more efficient airflow inside a form factor and also allows for smaller chassis designs.

Serial Attached SCSI (SAS) is a serial communication protocol for storage devices. SAS uses serial communication instead of the parallel method found in many SCSI devices but still uses SCSI commands for interacting with SAS devices. SAS supports up to 16,384 addressable devices in a SAS domain and point to point data transfer speeds up to 3 Gbit/s (e.g., in the future may be higher than 10 Gbit/s). The SAS connector is much smaller than traditional parallel SCSI connectors allowing for small 2.5 inch drives.

Serial ATA and SAS devices cannot work in environments where fibre channel is used as a transport mechanism, because the fibre channel standard does not support serial ATA and SAS protocols.

### SUMMARY

Firmware architecture of active-active fibre channel capability in SAS and SATA is disclosed. In one aspect, a system includes a processor and a memory connected to the processor having stored therein a conversion firmware to cause the processor to translate between a fibre channel frame (e.g., and other fibre channel frames on a frame by frame basis) and a SATA frame or a SAS frame. In this system, a data processing system may communicate through a fibre channel network with a storage device associated with the system (e.g., the system may be internal and/or external to the storage device). An active-active module of the conversion firmware may provide multiple paths from the data processing system to the storage device (e.g., to enable the processing of 128 concurrent commands from at least 32 data processing systems through the processor having separate payload buffers for data throughput from queue structures for processing header information).

A context (e.g., of a fixed size that may be allocated prior to receiving the fibre channel frame and other fibre channel frames) of the conversion firmware may be associated with one or more outstanding commands (e.g., including information comprising a MTU size, a SAS hash address, a fibre channel source identifier, an expected state, a pointer allocation for putting on queue, a command descriptor block (CDB)). An expected frame state (e.g., that may be created prior to forwarding the at least one of an expected fibre channel frame, an expected SATA frame, and an expected SAS frame) may be maintained to anticipate and expedite one or more of the expected fibre channel frame, the expected SATA frame, and the expected SAS frame processed by the conversion firmware. Also, an expected frame validation may include performing a protocol validation through one or more header validation operations.

The system may include a mapping module in the conversion firmware to translate between a logical block address and a logical block address count for one or more of a 520 block, a 524 block, and a 528 hard disk SCSI command and to a corresponding logical block address and a corresponding logical block address count for a 512 block SATA disk. The mapping module may flow through the translation while one or more of a next fibre channel frame, a next SATA frame, and a next SAS frame is processed by the conversion firmware.

In another aspect, a method using a conversion module having a firmware architecture includes analyzing an incoming command of an initiator and performing a conversion of the incoming command to a format of an output line, determining whether the incoming command is compatible with the output line, processing the incoming command internally if it is incompatible with the output line by applying an algorithm, and communicating the incoming command to a destination device if it is compatible with the output line. The method may further include updating an expected state of a next frame of the initiator using data provided in the incoming command, validating an incoming frame using one or more of a SAS, a SATA, and a fibre channel protocol, validating the initiator of the frame using a SCSI protocol, and processing a header data of the command in one or more queue structures and processing a payload data of the command in one or more payload buffers.

In yet another aspect, an article of manufacture is based on a machine readable medium having a machine readable program embedded in the medium wherein the program is comprised of functions for analyzing an incoming command of an initiator and performing a conversion of the incoming command to a format of an output line, determining whether the incoming command is compatible with the output line, processing the incoming command internally if it is incompatible with the output line by applying an algorithm, and communicating the incoming command to a destination device if it is compatible with the output line. The program may also update an expected state of a next frame of the initiator using data provided in the incoming command.

The methods may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 is a block diagram of a module having multiple fibre channel ports and a SATA port, according to one embodiment.

FIG. 2 is a block diagram of a module having multiple fibre channel ports and multiple SAS ports, according to one embodiment.

FIG. 3 is a network diagram of the modules of FIG. 1 and FIG. 2 operating in a fibre channel environment, according to one embodiment.

FIG. 4 is a block diagram of data segmentation, queuing, and buffering in the module, according to one embodiment.

FIG. 5 is a perspective view of a storage device associated with a device, according to one embodiment.

FIG. 6 is a diagrammatic representation of a data processing system capable of processing a set of instructions to perform any one or more of the methodologies herein, according to one embodiment.

FIG. 7 is a process flow of conversion between fibre channel and SATA signals from the fibre channel side using a conversion module having a firmware architecture, according to one embodiment.

FIG. 8 is a perspective view of a storage device which contains a conversion module within the storage device, according to one embodiment.

FIG. 9 is a level view of firmware architecture associated with the conversion system of FIG. 5 and/or FIG. 8, according to one embodiment.

Other features of the present embodiments will be apparent from the accompanying drawings and from the detailed description that follows.

### DETAILED DESCRIPTION

Firmware architecture of active-active fibre channel capability in SAS and SATA system and method is disclosed. In the following description, for purposes of explanation, numerous specific details are set forth in order to provide a thorough understanding of the various embodiments. It will be evident, however, to one skilled in the art that the various embodiments may be practiced without these specific details. An example embodiment provides a system which includes a processor and a memory connected to the processor having stored therein a conversion firmware to cause the processor to translate between a fibre channel frame and at least one of a SATA frame and a SAS frame.

In another example embodiment, a method using a conversion module having a firmware architecture includes analyzing an incoming command of an initiator and performing a conversion of the incoming command to a format of an output line, determining whether the incoming command is compatible with the output line, processing the incoming command internally if it is incompatible with the output line by applying an algorithm, and communicating the incoming command to a destination device if it is compatible with the output line.

Example embodiments of a method and a system, as described below, may be used to provide active-active fibre channel capability for SATA and SAS devices. It will be appreciated that the various embodiments discussed herein may/may not be the same embodiment, and may be grouped into various other embodiments not explicitly disclosed herein.

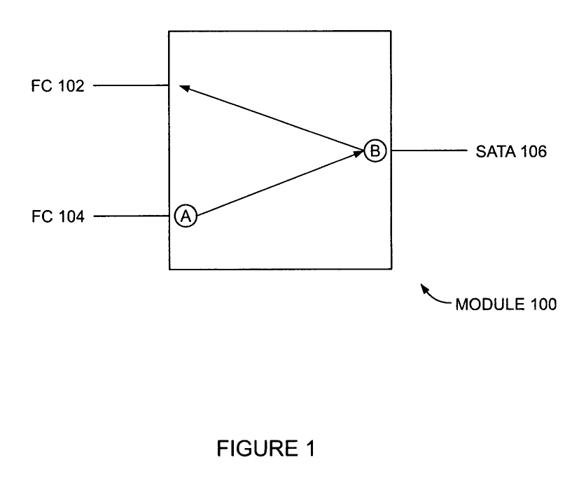

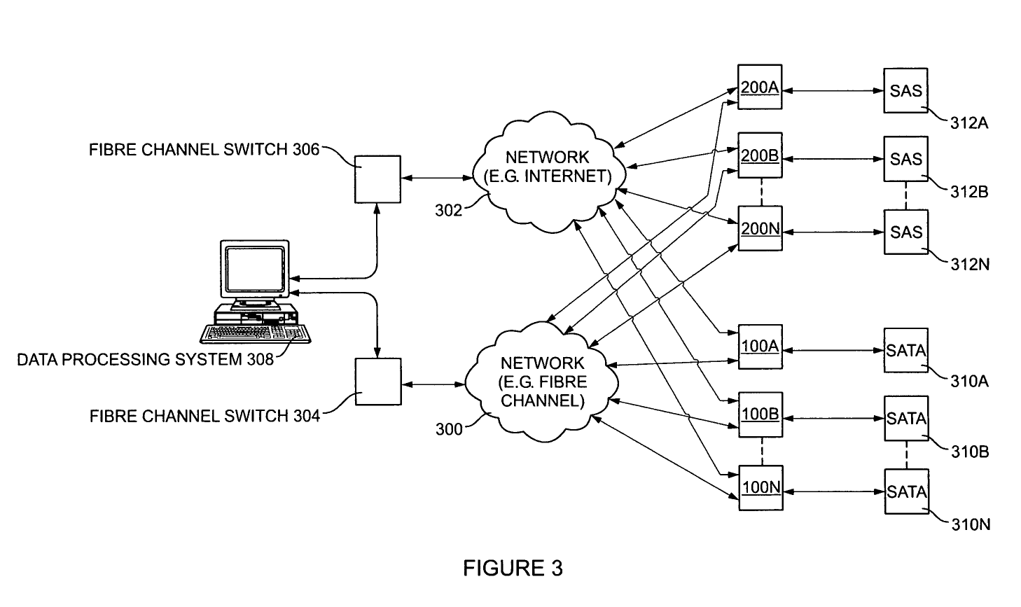

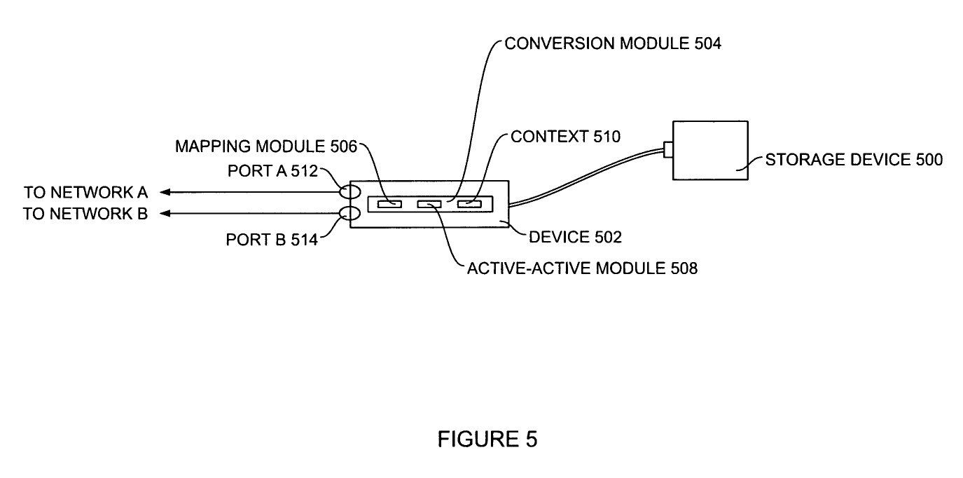

FIG. 1 is a block diagram of a module 100 having multiple fibre channel ports (a fibre channel port 102 and a second fibre channel port 104) and a SATA port 106, according to one embodiment. The fibre channel port 102 and the fibre channel port 104 may connected to different fibre channel switches. For example, the fibre channel port 102 may be connected to a fibre channel switch 304 in FIG. 3, whereas the fibre channel port 104 may be connected to a fibre channel switch 306 in FIG. 3. The SATA port 106 may be connected to a SATA storage device, such as a SATA hard drive (e.g., such as a SATA hard drive 310A). In an alternate embodiment, the SATA port 106 may be connected to circuitry in a conversion module 502 internal to a storage device as illustrated in FIG. 5, and another circuitry in a controller module 504.

Illustrated in FIG. 1 is a circle ‘A’ near the fibre channel port 104. The circle ‘A’ represents a communication path of frames of data from the fibre channel port 104 to the SATA port 106. First, a validation occurs of an initiator of a particular frame. For example, the initiator may be a data processing system 308 as illustrated in FIG. 3, and the module 100 may validate that a particular source identifier is associated with the data processing system 308 when a frame is received from the fibre channel port 104.

It should be noted that data flows through the module 100 and only the command is translated in one embodiment. Also, a frame size validation can be made. For example, a mapping module 506 of FIG. 5 (e.g., in a conversion module 504 of FIG. 5) of the module 100 may flow through a translation of the data (e.g., the conversion module 504 may translate a LBA and a LBA count in a SCSI command from the data processing system 308 that assumes the command is for a 520 block, a 524 block, and/or a 528 block hard disk to a proper LBA and a LBA count for a 512 block SATA disk).

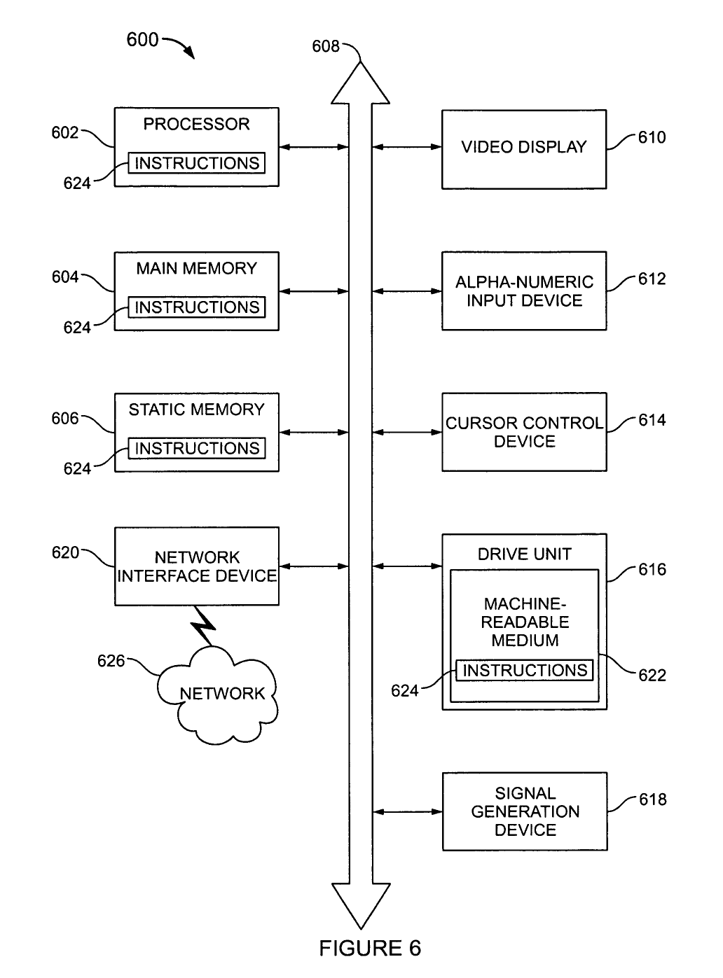

After the validation is made, an interpretation is made whether the incoming fibre channel frame includes a payload having a command that can be processed by a SATA protocol (e.g., read, write, etc.). If not, the module 100 may process incompatible commands (e.g., a verify command) internally (e.g., using a processor such as the processor 602 of FIG. 6), and return a response to an initiator (e.g., the data processing system 308 of FIG. 3).

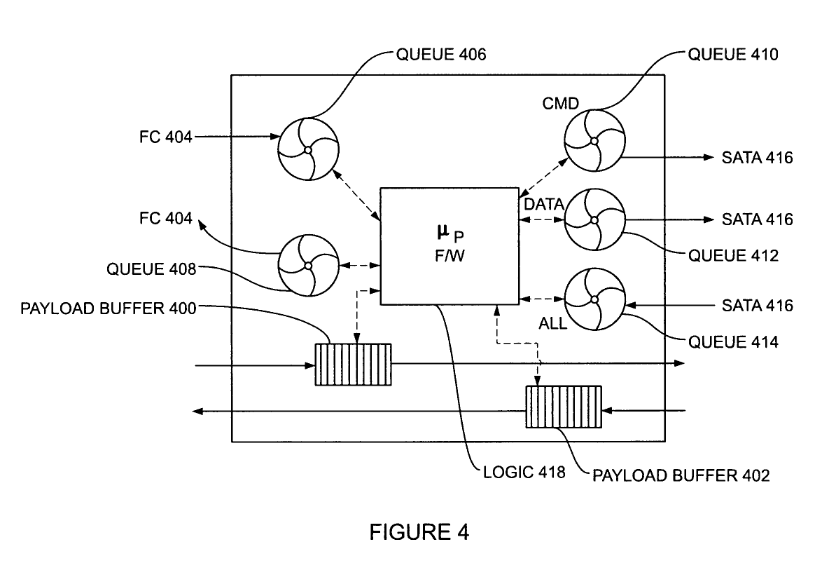

If the data is a compatible command, the module 100 may convert the command from a fibre channel protocol to a serial ATA protocol (e.g., using a logic 418 as illustrated in FIG. 4). In one embodiment, data received from the fibre channel port 102 and/or the fibre channel port 104 may provide multiple paths for load balancing or throughput purposes and a combined throughput from the multiple paths set may be provided to a SATA hard drive (e.g., the SATA hard drive 310A of FIG. 3) connected to the SATA port 106.

As a result, the SATA hard drive (e.g., the SATA hard drive 310A of FIG. 3) may work similarly in an active-active mode, or a mode that enables the SATA hard drive to provide multiple paths from the data processing system (e.g., the data processing system 308) to the storage device (e.g., while two ports are illustrated in FIG. 1, alternate embodiments of the module 100 of FIG. 1 may have any number of fibre channel ports). The data processing system 308 may not know that it is associated with a SATA hard drive while believing that it is associated with a dual ported fibre channel drive, according to one embodiment. In another alternate embodiment, if a network associated with the fibre channel port 102 fails (e.g., a network 300 of FIG. 3), then data may be transmitted over an alternate network over the fibre channel port 104 (e.g., such as over a network 302 as illustrated in FIG. 3).

In addition, illustrated in FIG. 1 is a circle ‘B’ near the SATA port 106. In the operation of circle ‘B’, the module 100 may check if a particular frame received is an expected frame by examining stored information from a previous frame having data about a next expected frame (e.g., a previous frame sent from a SATA device through the module 100A of FIG. 3 to the data processing system 308 of FIG. 3). Also, the module 100 may determine a particular command context (e.g., a set of attributes that give a meaning/value/parameter to a particular type of command). A validation may then be made of the frame (e.g., by checking if identification information of the header is what was expected). Then, the frame may be converted into a fibre channel frame from a SATA frame and sent out over either the fibre channel port 102 and/or the fibre channel port 104 (e.g., by using the logic 418 of FIG. 4).

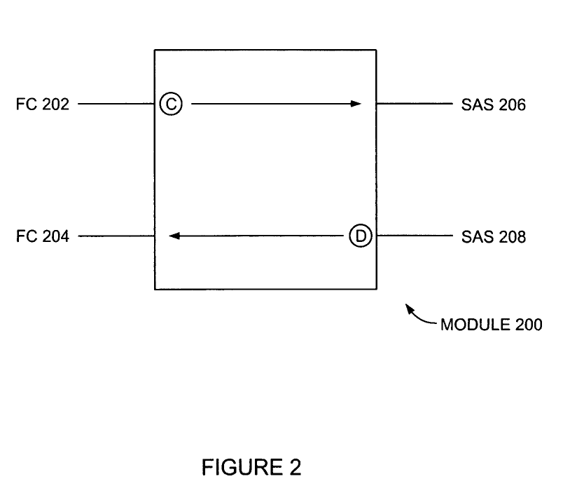

FIG. 2 is a block diagram of a module 200 having multiple fibre channel ports (e.g., a fibre channel port (FC) 202 and a fibre channel port (FC) 204) and multiple SAS ports (e.g., a SAS port 206 and a SAS port 208), according to one embodiment. The module 200 may be similar to module 100, but used to convert between fibre channel frames and SAS frames (e.g., in both directions), rather than between fibre channel frames and SATA frames (e.g., in both directions).

Illustrated in FIG. 2 is a circle ‘C’ near the fibre channel port 202. The operations of circle ‘C’ may involve the translation (e.g., conversion, processing, etc.) from fibre channel frames to SAS frames. First, an initiator (e.g., the data processing system 308) may be validated. Then the frame header (e.g., a frame header of an incoming fibre channel frame) may be validated (e.g., using an algorithm that examines a header having a source identifier). Next, an expected next header state may be updated (e.g., so the module 200 knows what type of frame to expect next). Then, the fibre channel frame may be converted to a SAS frame, and sent through the module 200.

In addition, illustrated in FIG. 2 is a circle ‘D’ near the SAS port 208. The operations of circle ‘D’ may involve translation (e.g., conversion, processing, etc.) from SAS frames to fibre frames. First, a frame header may be validated (e.g., similarly to the process discussed in circle ‘C’). Then an expected next state may be updated. A conversion may then be made to an outgoing fibre channel frame (e.g., by reformatting data into an appropriate frame size, and modifying header information). Finally, the data may be transmitted through the fibre channel port 204.

FIG. 3 is a network diagram of the modules of FIG. 1 and FIG. 2 operating in a fibre channel environment, according to one embodiment. Illustrated in FIG. 3 are a network 300, and a network 302. The data processing system 308 is coupled to the network 300 (e.g., fibre channel) through the fibre channel switch 304, and data processing system 308 is coupled to the network 302 (e.g. internet) through the fibre channel switch 306. In case the network 300 associated with the fibre channel switch 304 is disabled, then data may be transmitted over an alternate network 302 over the fibre channel switch 306.

SATA drives 310A, 310B, to 310N and SAS drives 312A, 312B, to 312N are coupled to the network 300 and the network 302 through devices 100A, 100B, to 100N (e.g., which are different versions of the module 100 of FIG. 1) and devices 200A, 200B, to 200N (e.g., which are multiple versions of the module 200 of FIG. 2), respectively. The devices 100A, 100B, to 100N process data between the SATA drives 310A, 310B, to 310N and the network 300, and the devices 200A, 200B, to 200N process data between the SAS drives 312A, 312B, to 312N and the network 302.

Data may be sent from the data processing system 308 through the fibre channel switch 306 and the network 302 into the module 100A in one port, and also from the data processing system 308 to the fibre channel switch 304 to the network 300 to the other port on the module 100A. Thus the module 100A may receive two inputs, one from the network 302, and one from the network 300. The SATA drives 310A, 310B, to 310N have single ports, but throughput of multiple fibre channel frames processed across different ports may enable multiple paths through the devices 100A, 100B, to 100N (e.g., fibre channel frames processed across 2 ports as shown in FIG. 1), thereby enabling the SATA drives to work in an active-active mode.

FIG. 4 is a block diagram of data segmentation, queuing, and buffering in a conversion module (e.g., the module 100 and/or the module 200), according to one embodiment. Shown in FIG. 4 are queues 406, 408, 410, 412 and 414, which are coupled with a logic 418, where commands are converted from a fibre channel (FC) protocol to a SATA protocol. Fibre channel commands are received into the queue 406. These commands may be received from an initiator (e.g., the data processing system 308 of FIG. 3).

Output headers are transmitted out from the queue 408 to the fibre channel (FC) 404. SATA signals are sent from a SATA 416 to the queue 414, where header information (e.g., which may be used to control link applications, control device protocol transfers, and detect missing or out of order frames) is stored and processed. The converted commands or the compatible commands are sent from the logic 418 to the queues 410 and 412, from where they are transmitted to the SATA 416. A payload (e.g., information to be transferred from a source port to a destination port) from the fibre channel side is sent directly to a payload buffer 400, and a payload from the SATA 416 side is sent into a payload buffer 402 for data throughput.

FIG. 5 is a perspective view of a storage device 500 associated with (e.g., connected to) a device 502 (e.g., the devices 200A to 200N or the devices 100A to 100N of FIG. 3), according to one embodiment. As illustrated in FIG. 5, the device 502 includes a conversion module 504, which further includes a mapping module 506, an active-active module 508, and a context 510. There are two ports illustrated with the device 502, a port A 512 and a port B 514 (e.g., fibre channel ports such as the fibre channel port 202 and the fibre channel port 204 of FIG. 2). The port A 512 connects the device 502 to a network A, while the port B 514 connects the device to a network B. The storage device 500 of FIG. 5 is connected to the device 502.

The conversion module 504 may translate between a fibre channel frame and a SATA frame and/or a SAS frame. The fiber channel frame may contain information to be transmitted (e.g., payload), an address (e.g., an IP address) of the source and/or the destination port, and/or link control information (e.g., information that controls a line, channel and/or circuit over which data are transmitted). In at least one embodiment, the conversion module 504 may process the fibre channel frame on a frame by frame basis (e.g., one frame at a time). In addition, a next frame state may be maintained to anticipate and/or expedite (e.g., to execute quickly and efficiently) a next fibre channel frame, a next SATA frame, and/or a next SAS frame processed by the conversion module 504. The next frame state may be validated prior to forwarding the next fibre channel frame, the next SATA frame, and/or the next SAS frame, such as by performing a protocol validation through at least one header validation operation.

An active-active module 508 of the conversion module 504 may provide multiple paths from the data processing system 308 to the storage device 500, and enable the processing of 128 concurrent commands from any number of data processing systems through a processor having separate payload buffers (e.g., the payload buffer 400 of FIG. 4) for data throughput from queue structures (e.g., the queue structure 414) for processing header information.

A mapping module 506 of the conversion module 504 may translate one of a 520 block, a 524 block and/or a 528 block size of a SCSI data in the fibre channel frame to a 512 block SATA frame. The mapping module 506 may flow through (e.g., pass through) the translation while a next fibre channel frame, a next SATA frame, and/or a next SAS frame is processed by the conversion module 504.

A context 510 (e.g., 132 frames of data) may be associated with at least one outstanding command, and the context 510 may include information such as a MTU size, a SAS hash address, a fibre channel source identifier, an expected state, a pointer allocation for putting on queue, and/or a command descriptor block (CDB). The context 510 may be of a fixed size and/or the context 510 may be allocated prior to receiving the fibre channel frame and other fibre channel frames.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media. The software 624 may further be transmitted and/or received over a network 626 via the network interface device 620.

While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

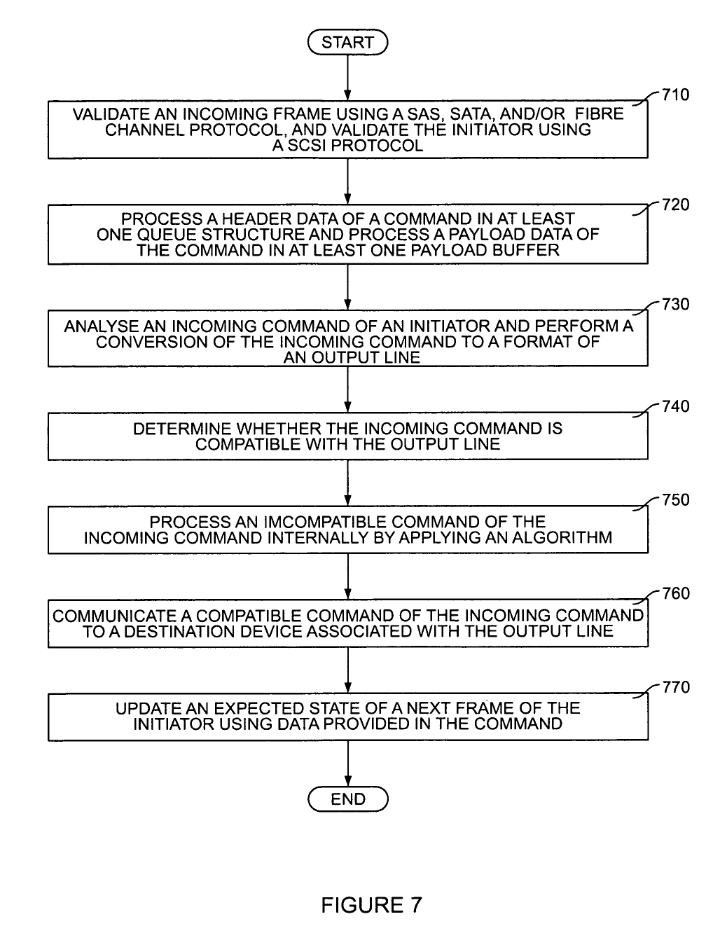

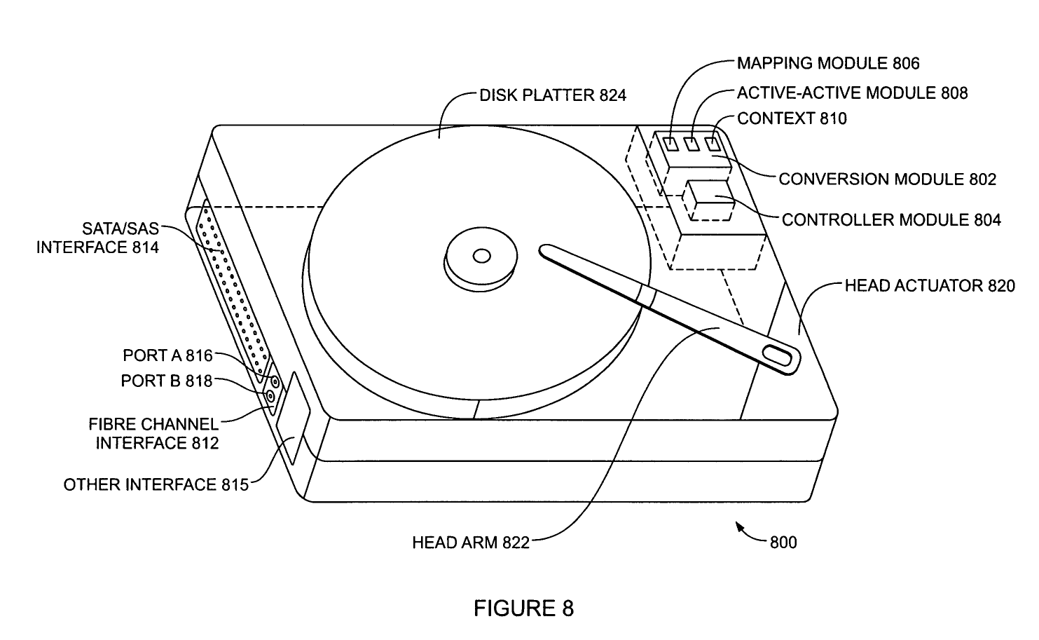

FIG. 7 is a process flow of conversion between fibre channel and SATA signals from the fibre channel side using a conversion module (e.g., in the device 502 of FIG. 5 and/or in a conversion module 802 of FIG. 8) having a firmware architecture, according to one embodiment. In operation 710, an incoming frame is validated using a SAS, SATA, and/or fibre channel protocol, and an initiator is validated using a SCSI protocol (e.g., by the logic 418). Then in operation 720, a header data is processed in one or more queue structures (e.g., the queue 406), and a payload data is processed in one or more payload buffers (e.g., the payload buffer 402). In operation 730, an incoming command of the initiator (e.g., from the data processing system 308 of FIG. 3) is analyzed and a conversion of the incoming command is made to a format of an output line (e.g., the output line may the SATA line connected to the module 100 of FIG. 1).

In operation 740, a determination is made whether the incoming command is compatible with the output line (e.g., the SATA/SAS side of the module 100/200). If the incoming command is incompatible, in operation 750, the incompatible command is internally processed by applying an algorithm. In operation 760, a compatible command is communicated to a destination device (e.g., a hard drive) associated with the output line. In operation 770, an expected state is updated of a next frame of the initiator using data provided in the command.

FIG. 8 is a perspective view of a storage device 800 which contains a conversion module 802 in the storage device 800, according to one embodiment. As illustrated in FIG. 8, the storage device 800 includes the conversion module 802, a controller module 804, a fibre channel interface 812, a SATA/SAS interface 814, an other interface 815, a head actuator 820, a head arm 822, and a disk platter 824. The conversion module 802 further includes a mapping module 806, an active-active module 808, and a context 810.

The conversion module 802 (e.g., the conversion module 802 and the data processing system 308 of FIG. 3 may be used to communicate fibre channel frames through a network) may translate between a fibre channel frame and a SATA frame and/or a SAS frame. The fiber channel frame may contain information to be transmitted (e.g., payload), an address of the source (e.g., an IP address), a destination port and/or link control information (e.g., information that controls a line, channel and/or circuit over which data are transmitted).

In one or more embodiments, the conversion module 802 may process the fibre channel frame and other fibre channel frames on a frame by frame basis (e.g., a frame with high priority may be processed before a frame with low priority). In addition, a next frame state may be maintained to anticipate and/or expedite (e.g., to execute quickly and efficiently) an expected fibre channel frame, an expected SATA frame, and/or an expected SAS frame processed by the conversion module 802 (e.g., the expected frame state may be created prior to forwarding the expected fibre channel frame, the expected SATA frame, and/or the expected SAS frame). The next frame state may be validated prior to forwarding the next fibre channel frame, the next SATA frame, and/or the next SAS frame (e.g., by performing a protocol validation through one or more header validation operations).

An active-active module 808 (e.g., in the conversion module 802) may provide multiple paths from the data processing system 308 of FIG. 3 to the storage device 800 (e.g., as described in FIG. 3). In addition, the active and active module 808 may process 128 concurrent commands from any number of data processing systems (e.g., the data processing system 308 of FIG. 3) through a processor having separate payload buffers from queue structures (e.g., to process header information at high data throughput).

A mapping module 806 (e.g., in the conversion module 802) may translate a 520 block, a 524 block and/or a 528 block size of a SCSI data in the fibre channel frame to a 512 block SATA frame. The mapping module 806 may flow through (e.g., to gauge the block size of the SCSI data) the translation while a next fibre channel frame, a next SATA frame, and/or a next SAS frame is processed by the conversion module 802.

A context 810 (e.g., 132 frames of data) may be associated with one or more outstanding commands. The context 810 may include information a MTU size, a SAS hash address, a fibre channel source identifier, an expected state, a pointer allocation for putting on queue, and/or a command descriptor block (CDB). The context 810 may be of a fixed size (e.g., a uniform number of bits and/or bytes). The context 810 may be allocated prior to receiving the fibre channel frame and other fibre channel frames.

The controller module 804 (e.g., in a circuit and/or a software module) may allow the data processing system 308 (e.g., illustrated in FIG. 3) to communicate with the storage device 800. Here, the controller module 804 may generate an output data that is responsive to data (e.g., the SATA frame and the SAS frame) from the conversion module 802. In addition the controller module 804 may process data fed directly through the SATA/SAS interface 814 (e.g., from a device that uses the SATA/SAS standard) to regulate a head actuator 820 (e.g., and/or other peripheral devices). The head actuator 820 may operate a head arm 822 to read and/or write information on a disk platter 824. The controller module 804 may also communicate back to the data processing system 308 of FIG. 3 through the conversion module 802.

There are three interfaces on the storage device 800. The SATA/SAS interface 814 may be used when the storage device 800 interfaces with a device using SATA and/or SAS commands. In this setting, the commands may bypass the conversion module 802 and may be fed into the controller module 804 directly. The fiber channel interface 812 may be used when the storage device 800 interfaces with a device using fibre channel frames. The fibre channel interface 812 may have two ports as illustrated in FIG. 8 (e.g., a port A 816 and a port B 818 may be similar to the fibre channel port 202 and the fibre channel port 204 of FIG. 2, respectively).

The port A 816 connects the conversion module 802 to a network A, while the port B 818 connects the conversion module 802 to a network B. It should be noted that what is illustrated here is just an example embodiment of the fibre channel interface 812. The fibre channel interface 812 may be implemented using multiple ports in addition to the two ports illustrated in this example while taking any number of physical forms encompassing any embodiment herein. The other interface 815 (e.g., an interface to a power source, a peripheral device, etc.) may be used to implement a connection to any devices.

In another example embodiment, an apparatus may include the conversion module 802 in the storage device 800 (e.g., a SAS device, a SATA device, etc.) to translate an incoming command of an initiator (e.g., the data processing system 308) to a format of a communication protocol associated with the storage device 800 (e.g., more specifically the controller module 804 in the storage device 800 coupled to the conversion module 802). The controller module 804 may generate an output data (e.g., which allows the CPU of a hosting data communication system to communicate with a hard disk, floppy disk and/or other kind of disk drive) responsive to the incoming command of the initiator (e.g., which may use data provided in the incoming command to update an expected state of a next frame of the initiator). Here, the incoming frame may be validated using a SAS, a SATA, and/or a fibre channel protocol. The initiator of the incoming frame may be validated through a SCSI protocol. The conversion module 802 may process a header data of the incoming command in one or more queue structures and a payload data of the incoming command in one or more payload buffers, as illustrated in FIG. 4.

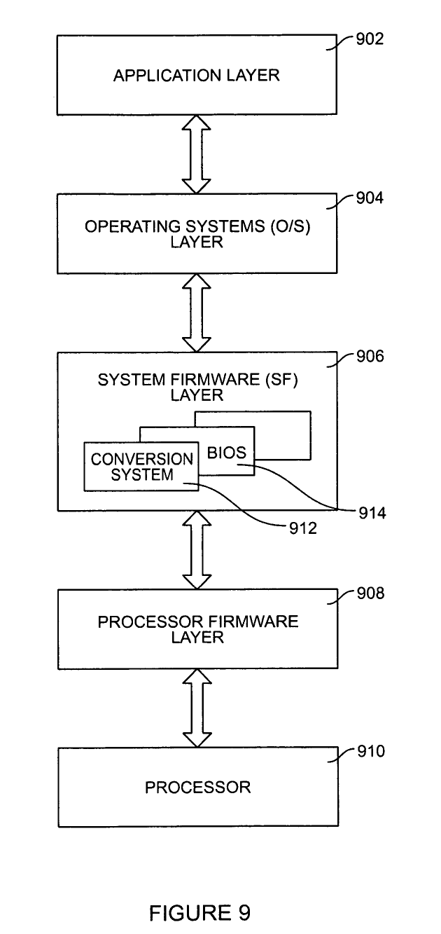

FIG. 9 is a level view of firmware architecture 900 associated with the conversion module 504/802 of FIG. 5 and/or FIG. 8, according to one embodiment. The architecture 900 contains an application layer 902, an operating systems (“O/S”) layer 904, a system firmware (“SF”) layer 906, a processor firmware layer 908, and a processor layer 910. The application layer 902 may include high level languages (e.g., COBOL, PASCAL, C, C++, Visual Basic, etc.) used by application programmers or users to solve problems. The O/S layer 904 (e.g., such as MS WINDOWS®, DOS®, UNIX®, LINUX®, etc.) may be used to support the application layer 902 by coordinating the use of hardware among various application programs.

The SF layer 906 is situated between the O/S layer 904 and the processor firmware layer 908. The SF layer 906 may include various control codes, such as a conversion system 912 and/or a basic input and output system (“BIOS”) 914 (e.g., to facilitate system operations). In one example embodiment, the conversion system 912 may be a memory (e.g., a conversion firmware) associated with the processor 910 to cause the processor 910 to translate between a fibre channel frame and at least one of a SATA frame and a SAS frame (e.g., the conversion system 912 may be used to perform functions illustrated in the conversion module 504 of FIG. 5 and/or the conversion module 802 of FIG. 8).

In another example embodiment, the conversion system 912 may be realized in an article of manufacture (e.g., a microchip) with a program code (e.g., performing functions for use in a digital processing system) embedded in the article to analyze an incoming command of an initiator and perform a conversion of the incoming command to a format of an output line (e.g., leading to either a fibre channel device or a SATA/SAS device). The conversion system 912 may also determine whether the incoming command is compatible (e.g., in the same format as the output line) with the output line, process the incoming command internally if it is incompatible with the output line by applying an algorithm (e.g., to transform the incoming command compatible with the output line), and communicate the incoming command to a destination device if it is compatible with the output line. The program code may further update an expected state of a next frame of the initiator using data provided in the incoming command.

The BIOS 914 software may have a number of different roles (e.g., one major role may be to load the operating system 904). When a user turns on a computer enabling the processor 910 to execute its first instruction, the processor 910 may have to get that instruction from somewhere. The processor 910 cannot get the instruction from the operating system 904 because the operating system 904 is located on a hard disk (e.g., the processor 910 cannot get to the instruction without some instructions that tell it how). The BIOS 914 provides those instructions.

The processor firmware layer 908 is situated between the SF layer 906 and the processor layer 910. The processor firmware layer 908 is often considered a part of a processing unit and is responsible for executing non-critical processing functions. The processor layer 910 (e.g., which may include execution devices, memory devices, decoders, etc.) may be situated at the lowest level. The processor layer 910 may further contain a digital layer where various circuits are used to implement logic functions.

Although the present embodiments have been described with reference to specific example embodiments, it will be evident that various modifications and changes may be made to these embodiments without departing from the broader spirit and scope of the invention. For example, the various modules, devices, contexts, queues, buffers, networks, etc. described herein may be performed and created using hardware circuitry (e.g., CMOS based logic circuitry), firmware, software and/or any combination of hardware, firmware, and/or software.

For example, the module 100/200/800, the device 502, the logic 418, the payload buffers 400/402, the queues 406-414, the controller module 804, the conversion module 504/802, the mapping module 506/806, the active-active module 508/808, the context 510/810, etc. may be embodied using transistors, logic gates, an electric circuits (e.g., application specific integrated ASIC circuitry) using a device circuit, a module circuit, a logic circuit, a payload buffer circuit, a queue circuit, a conversion circuit, a mapping circuit, an active-active circuit, a context circuit, etc. In addition, it will be appreciated that the various operations, processes, and the methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A system, comprising:
a processor; and
a memory coupled to the processor having stored therein a conversion firmware to cause the processor to translate between a fibre channel frame and at least one of a SATA frame and a SAS frame.

2. The system of claim 1 wherein a data processing system to communicate through a fibre channel network with a storage device associated with the system.

3. The system of claim 1 further comprising an active-active module of the conversion firmware to provide multiple paths from the data processing system to the storage device.

4. The system of claim 3 wherein the active-active module to enable the processing of 128 concurrent commands from at least 32 data processing systems through the processor having separate payload buffers for data throughput from queue structures for processing header information.

5. The system of claim 1 wherein the system is external to the storage device.

6. The system of claim 1 wherein the conversion firmware to process the fibre channel frame and other fibre channel frames on a frame by frame basis.

7. The system of claim 6 wherein a context of the conversion firmware is associated with at least one outstanding command.

8. The system of claim 7 wherein the context includes information comprising a MTU size, a SAS hash address, a fibre channel source identifier, an expected state, a pointer allocation for putting on queue, a command descriptor block (CDB).

9. The system of claim 8 wherein the context is of a fixed size and wherein the context is allocated prior to receiving the fibre channel frame and other fibre channel frames.

10. The system or claim 1 wherein an expected frame state is maintained to anticipate and expedite at least one of an expected fibre channel frame, an expected SATA frame, and an expected SAS frame processed by the conversion firmware.

11. The system of claim 10 wherein the expected frame state is created prior to forwarding the at least one of the expected fibre channel frame, the expected SATA frame, and the expected SAS frame.

12. The system of claim 11 wherein an expected frame validation includes performing a protocol validation through at least one header validation operation.

13. The system of claim 1 further comprising a mapping module of the conversion firmware to translate between
a logical block address and a logical block address count for at least one of a 520 block, a 524 block, and a 528 hard disk SCSI command and
to a corresponding logical block address and a corresponding logical block address count for a 512 block SATA disk.

14. The system of claim 13 wherein the mapping module to flow through the translation while at least one of a next fibre channel frame, a next SATA frame, and a next SAS frame is processed by the conversion firmware.

15. A method using a conversion module having a firmware architecture comprising:
analyzing an incoming command of an initiator and performing a conversion of the incoming command to a format of an output line;
determining whether the incoming command is compatible with the output line;
processing the incoming command internally if it is incompatible with the output line by applying an algorithm; and
communicating the incoming command to a destination device if it is compatible with the output line.

16. The method of claim 15 further comprising updating an expected state of a next frame of the initiator using data provided in the incoming command.

17. The method of claim 15 further comprising validating an incoming frame using at least one of a SAS, a SATA, and a fibre channel protocol, and validating the initiator of the frame using a SCSI protocol.

18. The method of claim 15 further comprising processing a header data of the command in at least one queue structure and processing a payload data of the command in at least one payload buffer.

19. The method of claim 15 in a form of a machine-readable medium embodying a set of instructions that, when executed by a machine, cause the machine to perform the method of claim 15.

20. An article of manufacture based on a machine readable medium having a machine readable program embedded in the medium, wherein the program is comprised of functions for:
analyzing an incoming command of an initiator and performing a conversion of the incoming command to a format of an output line;
determining whether the incoming command is compatible with the output line;
processing the incoming command internally if it is incompatible with the output line by applying an algorithm; and
communicating the incoming command to a destination device if it is compatible with the output line.

21. The article of manufacture of claim 20 wherein the program further comprising updating an expected state of a next frame of the initiator using data provided in the incoming command.
